(19) United States
(12) Patent Application Publication
(10) Pub. No.: US 2003/0144024 A1
(43) Pub. Date: Jul. 31, 2003

(54) Apparatus capable of providing multiple telephone numbers for cellular telephone

(76) Inventor: Chin-Fa Luo, Hsin-chu City (TW)

Correspondence Address: RABIN & BERDO, P.C., Suite 500, 1101 14th Street, N.W., Washington, DC, 20005, US

(21) Appl. No.: 10/058,271

(22) Filed: Jan. 30, 2002

(51) Int. Cl. H04Q 7/20

(52) U.S. Cl. 455/551; 455/466; 455/556

(57) ABSTRACT

An apparatus capable of providing multiple telephone numbers for a cellular phone includes a central processing unit connected to a random access memory and two erasable memories. One of the erasable memories stores common data of all the telephone numbers. The other one of the erasable memories stores non-common data. The central processing unit is provided with an external bus and two input ports coupled to the cellular telephone. One of the input ports receives a reset signal from the cellular telephone so as to control switching of the telephone numbers.

### BACKGROUND OF THE INVENTION

1. Field of the Invention

The invention relates to a wireless communications apparatus, more particularly to an apparatus capable of providing multiple telephone numbers for a cellular telephone.

2. Description of the Related Art

Wireless communications are developing by leaps and bounds such that mobile communications devices, such as mobile cellular telephones and personal digital assistants, have become popular. However, a cellular telephone is still inconvenient during use. For some reasons, it is common for a user to have multiple telephone numbers at the same time. As such, the user has to carry multiple mobile telephones, which is wasteful and inconvenient.

To overcome the problems associated with the use of multiple telephone numbers by a single user, a switching device was proposed, in which a SIM card seat in a cellular phone is modified, and a mechanical or electronic switch is additionally provided, thereby enabling switching different card seats to permit switching between telephone numbers. Although such technique can meet the object of using multiple telephone numbers with a single cellular phone, there are many drawbacks. Since the card seat has to be modified, the appearance or housing of the cellular phone will need to be modified as well. Besides, due to space limitations, the original card seat can be modified into two card seats or three card seats, and each of the card seats receives a SIM card. Switching between different card seats may result in poor electrical contact or unstable switching. Also, the card seats are likely to be damaged during battery replacement. Since there are provided many additional electronic components for switching purposes, there is increased power consumption, and insufficient power supply may result in undesirable shutdown of the cellular phone. In addition, the switching of telephone numbers requires the powering on and off of the cellular phone, which is inconvenient.

In order to solve the problems associated with the switching of telephone numbers and to overcome the aforesaid drawbacks, it is desirable to have an apparatus capable of providing multiple telephone numbers for a cellular phone.

### SUMMARY OF THE INVENTION

Therefore, the primary object of the present invention is to provide an apparatus capable of providing multiple telephone numbers for a cellular telephone, which permits quick switching of telephone numbers without the need to change telephone cards.

Another object of the present invention is to provide a cellular phone with an apparatus capable of providing multiple telephone numbers so that the same phone book and short messages can be commonly used when using different telephone numbers.

A further object of the present invention is to provide a multiple telephone number integrated circuit card that permits switching of telephone numbers without the need to modify a cellular telephone.

According to the present invention, an apparatus capable of providing multiple telephone numbers for a cellular telephone includes a central processing unit connected to a random access memory and two erasable memories. The two erasable memories respectively store common and non-common data of many telephone numbers. The central processing unit has an external bus and two input ports for coupling to a cellular telephone. The two input ports receptively receive a time pulse signal and a reset signal. The reset signal can activate the central processing unit to switch between telephone numbers.

### BRIEF DESCRIPTION OF THE DRAWINGS

The foregoing and other features and advantages of the present invention will be more clearly understood from the following detailed description and the accompanying drawings, in which,

FIG. 1 is a preferred embodiment of the present invention;

FIG. 2 is a flowchart of the apparatus shown in FIG. 1; and

FIG. 3 is an integrated circuit card fabricated from the apparatus of FIG. 1.

### DETAILED DESCRIPTION OF THE PREFERRED EMBODIMENT

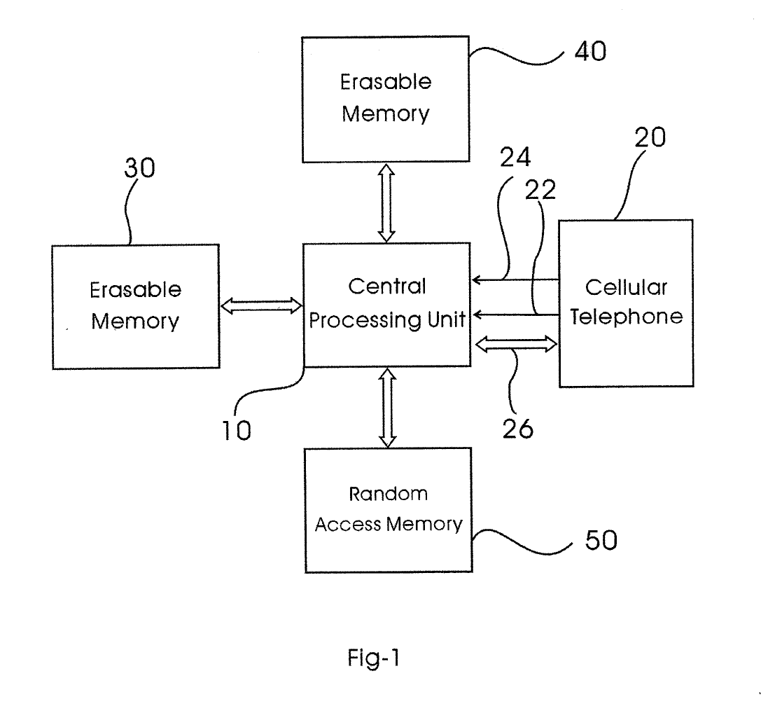

FIG. 1 shows a preferred embodiment of an apparatus capable of providing multiple telephone numbers according to the invention, which includes a central processing unit 10 connected to two erasable memories 30, 40, and a random access memory 50. The central processing unit 10 has two input ports 22, 24, and an external bus 26 for coupling to a cellular telephone 20.

The cellular telephone 20 transmits a time pulse signal and a reset signal to the input ports 22, 24 of the central processing unit 10, respectively. The reset signal is used to control switching of the telephone numbers. The erasable memory 30 stores non-common data of the telephone cards to facilitate telephone number management. The erasable memory 40 stores common data of the telephone cards, such as phone book and short messages, so that it is not necessary to input such data for each of the telephone numbers. In other words, data specific to each of the telephone numbers are stored in the erasable memory 30, while the common data are stored in the erasable memory 40. The random access memory 50 is provided to store data during operation of the central processing unit 10.

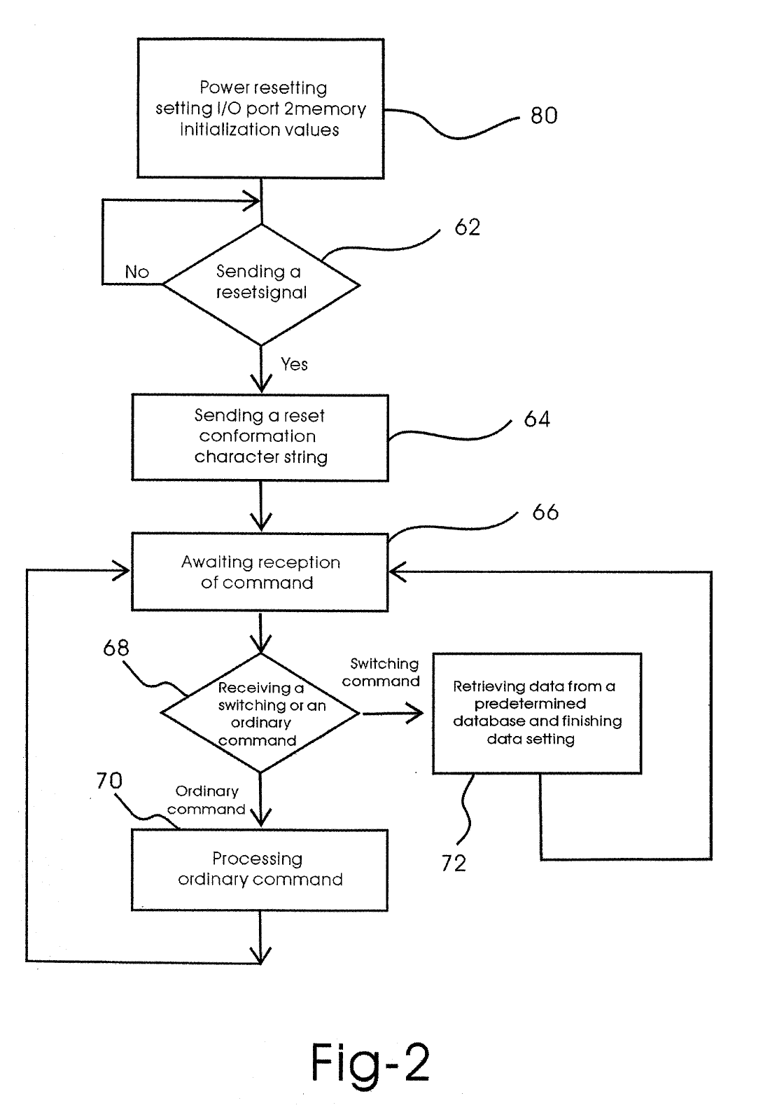

The flowchart of a system according to the invention is illustrated in FIG. 2. In step 60, as in the prior art, power is reset, and input/output (I/O) ports and memory initialization values are set. Then, in step 62, it is detected whether the cellular telephone 20 has sent a reset signal. In the negative, the flow returns to step 62. Otherwise, in step 64, the central processing unit 10 sends a reset confirmation character string. Subsequently, step 66 is carried out to await reception of a command from the cellular telephone 20. Next, in step 68, it is determined whether the command received is an ordinary command or a switching command. If the command is an ordinary one, step 70 is performed to process the ordinary command, and the flow then returns to step 66 to await another command. If it is a switching command that was received in step 68, step 72 is carried out to retrieve data from a predetermined database and finish data setting, i.e., switching to a new telephone number. Then, the flow returns to step 66 to continue waiting for a command. The switching of data can be accomplished by using a PIN code or a built-in menu.

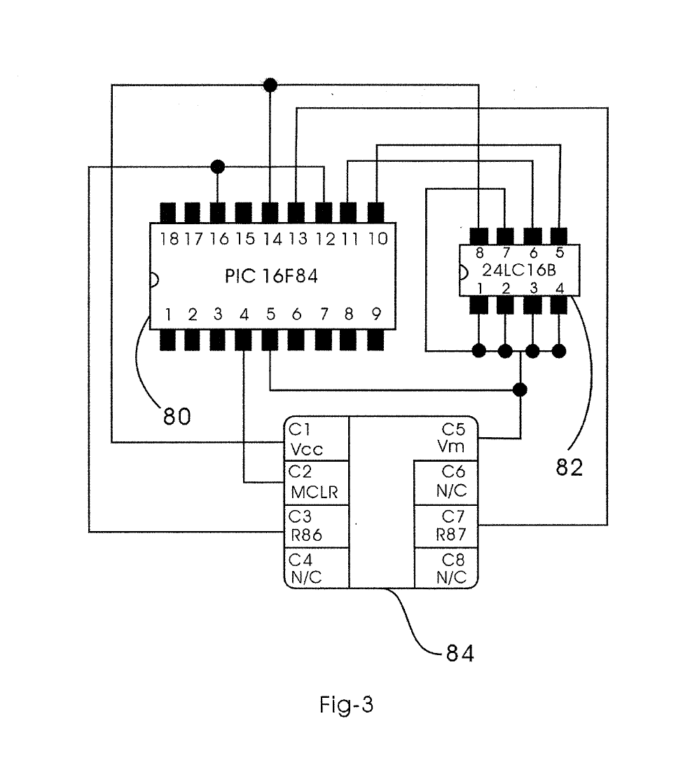

As shown in FIG. 3, a low voltage single chip 80 under serial number PIC 16F84 and a chip 82 under serial number 24LC16B are used to realize the apparatus shown in FIG. 1. The chip 80 serves as the central processing unit, while the chip 82 serves as the erasable memory. The apparatus is configured into an integrated circuit 84. Since a single integrated circuit card is used, and since all the telephone numbers and data are stored in the integrated circuit card, there is no need to modify the appearance or housing of the cellular telephone, and there is no need to provide additional circuits in order to accomplish the switching of multiple telephone numbers. Furthermore, the problems of mechanical breakdown, poor electrical contact, or insufficient power supply will not be present. As shown, a fourth pin of the chip 80 is connected to a second contact C2 (MCLR) of the integrated circuit card 84. A fifth pin of the chip 80 is connected to first to fourth pins and a seventh pin of the chip 82, and is also connected to a fifth contact C5 (Vm) of the integrated circuit card 84. A tenth pin of the chip 80 is connected to a fifth pin of the chip 82. An eleventh pin of the chip 80 is connected to a sixth pin of the chip 82. The twelfth and sixteenth pins of the chip 80 are connected to a third contact C3 (RB6) of the integrated circuit card 84. A thirteenth pin of the chip 80 is connected to a seventh contact C7 (RB7) of the integrated card 84. A fourteenth pin of the chip 80 is connected to an eighth pin of the chip 82, and is also connected to a first contact C1 (Vcc) of the integrated circuit card 84. This integrated circuit card 84 can contain up to 16 sets of SIM card numbers. The flash memory 82 used herein can be repeatedly used for a million times, is very stable, and will not cause shutdown of the cellular telephone.

The process of using the integrated circuit card 84 is illustrated hereinbelow. In a powering-off state, the integrated circuit card 84 is disposed inside the cellular telephone 20, and the power is turned on. The PIN code is inputted as required, and the system will automatically switch and set the phone book, short messages and card numbers according to the PIN code. The cellular telephone 20 then begins operation. If it is desired to switch telephone numbers in a power-on state, card switching is selected from a menu on the telephone, and the PIN code is inputted as required. The system will automatically switch and set the phone book, short messages and card numbers according to the PIN code. The cellular telephone will start searching anew. Hence, switching of telephone numbers is simple and quick, and there is no need to power off and then power on the telephone.

Although the present invention has been illustrated and described with reference to the preferred embodiment thereof, it should be understood that it is in no way limited to the details of such embodiment but is capable of numerous modifications within the scope of the appended claims.

I claim:

1. An apparatus capable of providing multiple telephone numbers for a cellular telephone, comprising:
a central processing unit having an input port;
a first erasable memory connected to said central processing unit for storing common data;
a second erasable memory connected to said central processing memory for storing non-common data; and
a random access memory connected to said central processing unit;
wherein said input port receives a reset signal so as to control switching of the telephone numbers.

2. The apparatus as claimed in claim 1, wherein the common data includes a phone book and short messages.

3. A cellular telephone integrated circuit card, comprising:
a central processing unit having an input port; and
a memory connected to said central processing unit for storing common and non-common data;
wherein said input port receives a reset signal so as to control switching of telephone numbers.

4. The cellular telephone integrated circuit card as claimed in claim 3, wherein the common data includes a phone book and short messages.

5. A cellular telephone, comprising:
a telephone;
a central processing unit having an input port that is connected to said telephone; and
a memory connected to said central processing unit for storing common and non-common data;
wherein said input port receives a reset signal from said telephone so as to control switching of telephone numbers.

6. The cellular telephone as claimed in claim 5, wherein the common data includes a phone book and short messages.
